(19) United States
(12) Patent Application Publication
(10) Pub. No.: US 2021/0160018 A1
(43) Pub. Date: May 27, 2021

(54) AUTOMATED CUSTOMIZATION WITH COMPATIBLE OBJECTS

(71) Applicant: Shenzhen Malong Technologies Co., Ltd., Shenzhen (CN)

(72) Inventors: Xintong HAN, Shenzhen (CN); Weilin HUANG, Shenzhen (CN); Matthew Robert SCOTT, Shenzhen (CN)

(21) Appl. No.: 16/696,184

(22) Filed: Nov. 26, 2019

(51) Int. Cl. H04L 1/24; G06Q 30/06; G06F 8/20; G06Q 40/02; G06Q 20/10; G06Q 20/40

(52) U.S. Cl. CPC H04L 1/244; G06Q 30/0629; G06Q 30/0643; G06Q 20/403; G06Q 40/02; G06Q 20/108; G06F 8/20

(57) ABSTRACT

This disclosure includes technologies for ranking or generating compatible objects. In retail-oriented applications, the disclosed technologies can rank products based on their respective compatibilities with contextual products, both in shape and appearance, and facilitate users to select products compatible with contextual products or surrounding conditions. In design-oriented applications, the disclosed technologies can generate diverse objects compatible with contextual objects or surrounding conditions.

### BACKGROUND

Electronic commerce (e-commerce) represents an ever-growing share of the retail market. Except for some goods or services that are not typically bought online like fuel from gas stations or dining experience at restaurants, online shopping has empowered consumers to buy virtually any goods or services over the Internet, and enjoy them in the comfort of their own homes after delivery.

Products may be sold individually, but hardly anything exists in complete isolation. People often want to buy compatible products. As an example, a piece of clothing (e.g., a hat, a shoe, etc.) usually is not bought out of context. Instead, shoppers would prefer a new item to be compatible with the rest of the clothes, such as a blouse, a shirt, a coat, a skirt, shoes, or even the socks. As another example, when a shopper is to select a piece of furniture (e.g., a recliner chair, an armchair, a rocking chair, etc.), the shopper likely would prefer the new piece of furniture to be compatible with other furniture in the home already, such as the love seat, the couch, the ottoman, the entertainment center, the tables, etc.

In bricks-and-mortar retailers or shopping centers, shoppers can vary the arrangements of different physical products and instantly obtain visual confirmation for their compatibility. However, such experience is challenging to reproduce online at least because it is cost prohibitive for online retailers to showcase the permutations of arrangements of their compatible goods. For example, it is expensive to hire models and photographers to produce marketing material to cover even only a few flagship products, let alone the permutations of all compatible products.

Incompatible products may be disposed in a landfill or at best returned. A high return rate encroaches the profitability of online retailers and negatively impacts on e-commerce. To solve these problems, online retailers need a technical solution to determine compatibility for products, and by the same token, enable consumers to view, select, and purchase compatible goods.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, aspects of this disclosure include a technical solution to generate compatible objects or measure compatibility based on shape compatibility and appearance compatibility with contextual objects. To do that, the disclosed system is to use a shape generation network to model the shape compatibility and an appearance generation network to model the appearance compatibility. The shape generation network and the appearance generation network encode compatibility information in a learned latent compatibility space, where compatible objects are modeled to have similar distributions, so that the disclosed system may measure compatibility or constrain the generated shapes and appearances to be compatible with contextual objects in the learned latent compatibility space. Further, a graphic user interface (GUI) is configured to present compatible objects and enable customization with the compatible objects. This uniquely designed GUI is configured to help users intuitively and quickly find compatible objects and further improves the efficacy of customization.

In various aspects, systems, methods, and computer-readable storage devices are provided to improve a computing device's ability to, in respect to contextual objects, measure compatibility, generate diverse compatible objects, and further customize with compatible objects. One aspect of the technologies described herein is to improve a computing device's ability to generate diverse compatible shapes for a target class. Another aspect of the technologies described herein is to improve a computing device's ability to generate diverse compatible appearances for the target class. Yet another aspect of the technologies described herein is to improve a computing device's ability to compare or rank objects based on their respective compatibility measures in respect to their contextual objects.

### BRIEF DESCRIPTION OF THE DRAWINGS

The technologies described herein are illustrated by way of example and not limited in the accompanying figures in which like reference numerals indicate similar elements and in which:

FIG. 1 is a schematic representation illustrating an exemplary GUI for viewing or generating a compatible object, in accordance with at least one aspect of the technologies described herein;

FIG. 2 is a schematic representation illustrating another exemplary GUI for viewing or generating a compatible object, in accordance with at least one aspect of the technologies described herein;

FIG. 3 is a schematic representation illustrating an exemplary customization system, in accordance with at least one aspect of the technologies described herein;

FIG. 4 is a schematic representation illustrating an exemplary shape network, in accordance with at least one aspect of the technologies described herein;

FIG. 5 is a schematic representation illustrating an exemplary appearance network, in accordance with at least one aspect of the technologies described herein;

FIG. 6 is a flow diagram illustrating an exemplary process of displaying a compatible object, in accordance with at least one aspect of the technologies described herein;

FIG. 7 is a flow diagram illustrating an exemplary process of generating a compatible object, in accordance with at least one aspect of the technologies described herein;

FIG. 8 is a flow diagram illustrating an exemplary process of measuring compatibility, in accordance with at least one aspect of the technologies described herein; and

FIG. 9 is a block diagram of an exemplary computing environment suitable for use in implementing various aspects of the technologies described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

For online shopping, unlike in brick-and-mortar retailers, online shoppers lack meaningful ways to verify whether multiple products are visually compatible, especially when different products are placed in different webpages. However, visual compatibility plays an important role in customer satisfaction. By way of example, it is frustrating to find out a piece of clothing does not fit with others only after its delivery. A product return is at minimum a hassle for both retailers and shoppers.

To partially resolve shoppers' compatibility concerns, online retailers could present different products in a compatible set. However, this solution does not work when shoppers are not planning to buy a set of products. By way of example, online retailers cannot predict whether a single product might be compatible with what is in a customer's home or what is worn by a customer presently. Accordingly, online retailers or shoppers need new technologies for predicting the compatibility among different products.

Compatibility is also an important issue in image generation or image synthesis to achieve realistic effects. The advancement in machine learning has made image generation popular in the design industry, film industry, advertisement industry, game industry, etc., such as for generating artificial cartoons, artificial faces, artificial characters, artificial designs, etc. Generative adversarial networks (GANs) are commonly used in image generation. To control the quality of generated images with desired properties, various supervised knowledge like class labels, attributes, text, and images are used. However, the existing image generation or synthesis methods generally lack considerations for the compatibility of different parts in an artificial image. By way of example, in the context of generating an artificial person, conventional methods often focus only on rendering clothes conditioned on pose, textual descriptions, textures, etc. Resultantly, different parts of the generated artificial person may be incompatible. Accordingly, new technologies for predicting the compatibility among different parts in a synthesized or generated image are needed for creating photorealistic images.

In this disclosure, a technical solution is provided for automated customization with compatible objects. Customization, also known as personalization, comprises tailoring a service or a product to accommodate a specific individual or a group of individuals. To achieve it, a compatible object is automatically determined based on its contextual objects. The compatible object, such as a compatible product, may then be used for customization. In some embodiments, the compatible object is selected from existing objects based on their compatibility measures with the contextual objects. In other embodiments, the compatible object is generated based on one or more compatibility constraints with contextual objects.

Compatibility generally refers to the effect that multiple objects can coexist or function in harmonious or agreeable combination. In the functional aspect, compatible objects are complimentary so that they can collectively achieve a function. As an example, all products in the plumbing section in a hardware store may be deemed as compatible due to their overall utility in plumbing projects. As another example, skis, ski poles, and goggles may be deemed as compatible as they are used for the same sport. As yet another example, neckwear, dresses, and footwear may be deemed as compatible in terms of clothing types as they are complementary to each other. However, sizes, genders, seasons, styles, etc., may make items in two otherwise complementary clothing types to be incompatible. For instance, an extra-large jacket may be incompatible with an extra-small pants due to their disparity in sizes. In the aesthetic aspect, compatible objects commonly have harmonious disposition or tastes, such as in color, shape, appearance, style, or other aesthetic features.

At a high level, the disclosed solution is to determine compatibility based on a two-stage framework, which addresses shape compatibility and appearance compatibility with contextual objects in two stages. In various embodiments, both the functional aspect and the aesthetic aspect of compatibility can be modeled into the shape compatibility model and the appearance compatibility model. In some embodiments, the disclosed system utilizes a shape generation network and an appearance generation network to generate shape and appearance sequentially. A shape generation network may be used to model the shape compatibility, and an appearance generation network may be used to model the appearance compatibility. The shape generation network or the appearance generation network encodes shape or appearance compatibility information in a learned latent compatibility space, where the disclosed system may measure compatibility or constrain the generated shapes or appearances to be compatible with contextual objects in the learned latent compatibility space.

In one embodiment, to generate compatible objects, each of the shape and appearance generation networks contain an encoder-decoder generator, which generates new images through reconstruction, and a two-encoder network, in which the two encoders interact with each other to encourage diversity while preserving visual compatibility. In the two-encoder network, one encoder learns a latent representation of the target object, which is constrained by the latent code from another encoder, which encodes information from contextual objects. Further, the latent representations of the target object and contextual objects are jointly learned with the encoder-decoder generator to condition the generation process. Furthermore, to measure the compatibility between a target object and its contextual objects, their respective latent representations may be compared in the learned latent compatibility space, e.g., based on their cosine similarity. Resultantly, both generation networks can learn high-level compatibility correlations among different objects in two different aspects, i.e., shape and appearance.

Neural networks are used in the shape generation network or the appearance generation network in various embodiments. Compatible objects for training may be manually labeled, or automatically labeled based on their co-occurrence information. To build labeled training data, as an example, different parts that co-occur in a same product may be labeled as compatible. As another example, different pieces of clothing worn by a same model may be labeled as compatible. As yet another example, different pieces of furniture placed in the same room in a furniture catalog may be labeled as compatible.

Technical solutions are provided for customization with compatible objects, which will be further discussed in connection with various figures. In some embodiments, when an input image is received by the disclosed customization system, an indication of a target class may be provided by users or otherwise automatically identified by the disclosed system. By way of example, the system may identify and classify different segments of the image into different classes. The known segments in the image may be treated as contextual objects. Further, the disclosed system can identify the target class based on the segments of the image. For instance, a missing segment or class, derived from identified segments or classes in the image, may be deemed as the target class. Knowing the target class and the contextual objects, the disclosed system is to identify objects in the target class that are compatible to the contextual objects. Based on the shape compatibility model and the appearance compatibility model, such compatible objects may be selected from preexisting objects or generated dynamically by the disclosed system. Further, compatible objects may be presented to users in an order based on their compatibility measures, so that users can effectively and efficiently locate the most compatible products. Finally, a compatible object may be placed at an appropriate location of the image, so that the compatible object and its contextual objects may form a harmonious or agreeable combination.

Various specially designed graphical user interfaces (GUIs) are configured to present compatible objects and enable customization with the compatible objects. Some GUIs are configured to help users intuitively and quickly identify compatible objects and further improve the efficacy of customization. Some GUIs are configured to help users visualize new designs with artificial compatible objects generated by the disclosed system, especially when viewed with contextual objects.

Advantageously, online retailers can use the disclosed technologies to provide purchase recommendations or enhanced customization services. For example, an online retailer can use the disclosed technologies to present compatible products (e.g., a set of different hats) in a customized page based on the clothes worn by a customer. Conversely, the disclosed technologies can help consumers locate compatible products and make purchases with confidence. For example, a lady can use the disclosed technologies to purchase a compatible hat based on her dress, by selecting the dress first from the merchant, or uploading an image of the dress to the merchant. In another direction, designers can use the disclosed technologies to visualize many design options with machine-generated compatible objects, thus to expedite their design processes.

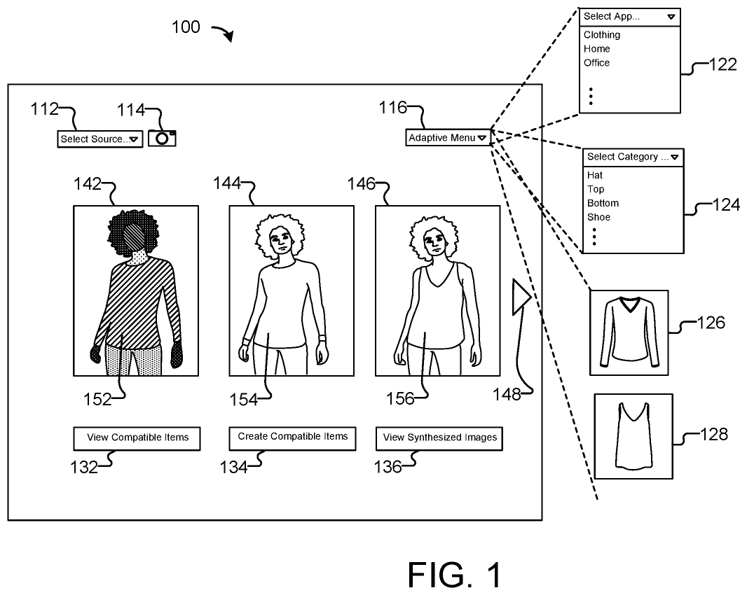

Having briefly described an overview of aspects of the technologies described herein, an exemplary practical application for viewing or generating a compatible object is described below. Specifically, referring now to FIG. 1, a schematic representation is provided illustrating an exemplary user interface for selecting compatible clothes from stock or generating diverse compatible clothes on demand. This exemplary user interface is designated generally as graphical user interface (GUI) 100.

The disclosed technologies can be applied to many different industries, although the following discussions of the practical application in FIG. 1 primarily refer to the fashion industry. For viewing or generating compatible objects, given contextual objects (e.g., some items of clothing worn by a person) and an indication of the target class (e.g., a type of clothing), the disclosed system is to provide recommendations of objects (e.g., images of the type of clothing) in the target class that are compatible with the contextual objects. These compatible products may be selected from an inventory or dynamically generated based on the contextual objects. Further, the compatible object may be presented in an agreeable combination with the contextual objects, as illustrated in FIG. 1.

As illustrated, GUI 100 has different UI elements (e.g., input controls, navigation components, informational components, containers, etc.) in different locations of the GUI for enabling users to view, select, or generate compatible objects. GUI 100 is designed to greatly improve a user's experience, e.g., for initiating a practical application, for selecting or generating a source with contextual objects, and identifying a target class, as well as viewing, selecting, or generating compatible objects. Resultantly, GUI 100, when enabled by the disclosed technologies, can enable users to expediently and conveniently find a target object that is compatible with its contextual objects. On the other hand, GUI 100, when enabled by the disclosed technologies, can enable users to make new designs, e.g., by generating creative objects that are compatible with its contextual objects.

In this embodiment, element 116 is an adaptive menu, which allows users to interact with the system in different levels based on the context. Element 112 and element 114 are input controls, which allow users to input information into the system. Element 148 is a navigational control, which allows users to navigate to additional information. Element 132, element 134, and element 136 are additional controls to cause different actions. Element 142, element 144, and element 146 are mainly informational components to display information, although they are also configured to allow users to input information to the system, as further discussed below.

Element 116 enables users to select a specific application, e.g., related to selecting or generating the compatible objects in clothing, home, office, etc., as illustrated in element 122. In this instance, the clothing application is selected. Element 112 and element 114 enable users to select a source that contains the contextual objects for the present application. Specifically, element 112 is configured to select the source from a local or network file system, including a local database or a remote cloud storage. Element 114 is configured to generate the source by taking a picture of an object or a person. For example, element 114 may be used to activate an imaging app, which further engages an imaging device operatively connected to the disclosed system, for taking the picture.

The selected source, typically including one or more images, is displayed in element 142. In some embodiments, a segmentation map of the source is displayed. The segmentation map generally shows the boundaries among different classes of objects. In this instance, the segmentation map of the person shows different segments or different clothing classes recognized by the system. In this way, users may intuitively select a particular segment to indicate the target class. For example, if the user selects segment 152, the system will interpret the target class as the “top.” In some embodiments, users can select the target class from element 116, which adapts to the current state of GUI 100 and may now list different classes or categories of clothing. Here, the user may select the target class of “top,” which is visible in element 142; alternatively, the user may select the target class of “shoe,” which is not presently visible in element 142.

In some embodiments, in response to a target class being selected, the system will mask out the segment corresponding to the selected target class, so that users can get a visual confirmation of the target class. By way of example, if a user selects “top,” element 142 will display the segmentation map of the person with segment 152 being masked out. Subsequently, a compatible object in the target class may be loaded to fit with the masked out segment.

In this example, the source image, either loaded via element 112 or element 114, is being displayed as a segmentation map in element 142. The system will automatically update the menu in element 116 based on the context. After the source image is loaded into element 142, element 124 becomes available for users to choose the target class. Here, the system recognizes the target class as the “top” clothes when the user selects segment 152 directly from element 142 or selects the menu option of “top” from element 124. Some or all of the remaining segments, other than segment 152, becomes the context objects for determining compatible objects in the target class.

Enabled by the disclosed technologies, the system then determines compatible top clothes based on the contextual objects, which include other classes of clothing in the source image, such as bottom clothes, shoes, etc. The compatible top clothes may be selected from the inventory in response to an activation of element 132 to view compatible items or element 136 to view synthesized images. Alternatively, the compatible top clothes may be dynamically generated in response to an activation of element 134 to create compatible items.

In some embodiments, element 116 is populated with the compatible top clothes, such as item 126 and item 128, for user selection. In response to a user selection, the selected item will be synthesized with the contextual object to form a new image. The new image may replace the source image in element 142. Alternatively, the new image may be comparatively presented with the source image, such as in element 144. When multiple compatible objects are selected, multiple synthesized images can be generated with respective compatible objects, such as top 154 in element 144 and top 156 in element 146. When element 148 is activated, more synthesized images with compatible objects may be presented to the user. In some embodiments, in response to the activation of element 132, the compatible objects are individually presented in element 144, element 146, and so forth. In some embodiments, users may drag and drop an individual compatible object, e.g., from a pop-up menu from element 116, or from element 144 or 146, to the source image, and the system will then synthesize the compatible object with the contextual objects.

In some embodiments, the user selection of one or more compatible objects is unnecessary. For example, the compatible top clothes may be automatically synthesized with the contextual objects, and one or more synthesized images are presented to users in response to the activation of element 136 to view synthesized images. In some embodiments, the order for presenting the compatible objects is based on their respective compatibility measures. For example, the top ranked compatible object (e.g., item 126) may be presented at a prominent position, such as at the top of the menu, or in the first synthesized image.

Having discussed the general operations of GUI 100, it should be noted that the specific location, structure, labeling, or presentation of a GUI element as illustrated is not intended to suggest any limitations as to the scope of design or functionality of the GUI element. It has been contemplated that a GUI element may relocate to another location in the GUI or vary in presentation without limiting the advantageous design principles and functions provided by GUI 100. As an example, switching the locations of various control elements, converting the horizontal display pattern to the vertical display pattern, changing a drop-down menu to a list menu, changing the label of a GUI element, etc., may not alter the disclosed design principles and advantages of GUI 100.

GUI 100 may be integrated with an e-commerce site, and further adapted to either regular displays (e.g., computer displays) or smaller displays (e.g., smartphone displays). Via GUI 100, when enabled by the disclosed technologies, retailers or e-commerce platforms can customize their products for users based on a dynamic user input, including a picture taken in real time. Advantageously, retailers or e-commerce platforms can now recommend products compatible with contextual objects presented in the dynamic user input. This new level of customization will greatly improve customer satisfaction and result in increased sales and reduced returns.

GUI 100 may be integrated with design applications, where a designer can visualize diverse design ideas, and further verify the compatibility with synthesized images. By way of example, a cartoon or video game designer may utilize GUI 100, including the disclosed technologies, to design a set of compatible outfits for a character, or even design a host of characters with shared latent attributes in a latent compatibility space, which is further discussed in connection with other figures.

Regardless of the specific applications, GUI 100 is advantageous in presenting compatible objects individually or in natural combination with contextual objects. In one aspect, users can view compatible objects individually, e.g., by activating element 132 or from automatically adapted menu under element 116. In another aspect, a user can view synthesized images, where a compatible object is mixed with its contextual objects in an agreeable combination, e.g., by activating element 136. Further, both the compatible objects and the synthesized images are configured to be presented comparably against each other, also in comparison with the source image. Resultantly, users can easily identify their preferred compatible object, or their preferred products for purchase in this case. Further, users can get instant photorealistic feedback, such as the synthesized images with compatible objects.

Further, traditional menus are typically designed in a tree structure. Resultantly, it will take quite some effort to traverse the tree, especially the desired menu item is located in a leaf node. Here, element 116 includes an adaptive menu, which changes the actual menu based on the context, as discussed before. Advantageously, users can directly navigate to the desired menu item without any need to traverse any tree structures.

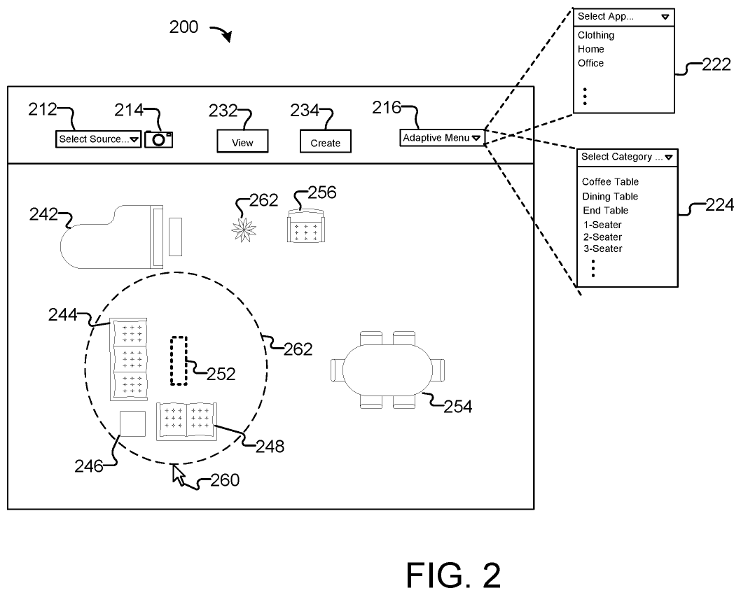

Turning now to FIG. 2, it is a schematic representation illustrating another exemplary GUI 200 for viewing or generating a compatible object, specifically an article of furniture in this embodiment. In other embodiments, GUI 200, like previously discussed GUI 100, may be used in e-commerce for various products in many different industries.

Via GUI 200, the disclosed system allows users to select a target class, define the contextual objects (e.g., several articles of furniture) manually or alternatively automatically, and provide recommendations of objects (e.g., images of the type of furniture) in the target class that are compatible with the contextual objects. These compatible products may be selected from an inventory or dynamically generated based on the contextual objects. Further, the compatible object may be presented in an agreeable combination with the contextual objects via GUI 200.

Resultantly, GUI 200, when enabled by the disclosed technologies, can enable users to expediently and conveniently locate an article of furniture that is compatible with its contextual objects. Further, GUI 200 can enable users to make new designs, e.g., for interior design, game design, graphical design, etc., by generating new objects that are compatible with their contextual objects.

In various embodiments, element 216 is an adaptive menu, which allows users to interact with the system in different levels based on the context. At one level, element 216 enables users to select a specific application, e.g., related to selecting or generating the compatible objects in clothing, home, office, etc., as illustrated in element 222. In this instance, the Home application is selected. At another level, element 216 enables users to select a target class, e.g., a type of furniture, as illustrated in element 224.

Element 212 and element 214 are input controls, which allow users to input information into the system. Element 212 and element 214 enable users to select a source that contains the contextual objects for the present application. Specifically, element 212 is configured to select the source from a local or network file system, including a local database or a remote cloud storage. Element 214 is configured to dynamically generate a source object by taking a picture of the object. In this instance, many articles of furniture are presented via GUI 200, including piano 242, plant 262, chair 256, couch 244, love seat 248, end table 246, dining table 254, etc.

GUI 200 is configured to enable users to define a target class, e.g., by using cursor 260 to select a shown article of furniture. For example, if love seat 248 is selected, the system will interpret the target class as the 2-seater type. Users may also select the target class from element 224, which populates various classes of furniture.

GUI 200 is also configured to enable users to define the contextual objects, e.g., by using cursor 260 to select various articles of furniture. In response to the user selection, the system may present a visual confirmation, such as highlighting the selected contextual objects, change the front color or the background of the selected contextual objects, etc. In one embodiment, such visual confirmation includes a visual boundary indicator, e.g., circle 262, especially when the selected contextual objects form a boundary.

In one embodiment, the user may also indicate the target class by drawing a target location. For example, when the user uses cursor 260 to draw location 252, the system will automatically determine a target class based on the contextual objects near location 252. In one embodiment, an indication (e.g., circle 262) of the contextual objects in respect to location 252 becomes visible. Circle 262 shows a boundary condition, such as a predetermined distance from location 252, which communicates to users that all articles of furniture inside of circle 262 are now considered as contextual objects. Further, users can manually add or delete a contextual object, e.g., by selecting with cursor 260. Advantageously, the system can identify more accurate contextual objects, thus improving the accuracy in determining the target class.

Subsequently, the system can intelligently determine the target class, based on the location as well as the contextual objects. In some embodiments, when the count of classes is limited, their relationship may be learned, and rule-based furniture arrangement schemas may be defined. For instance, the system can predicate the target class as the “coffee table” class as a coffee table is typically placed before a 3-seater or 2-seater in various furniture arrangement schemas.

Enabled by the disclosed technologies, the system determines compatible objects based on the contextual objects, which include various articles of furniture in the target class. Element 232 and element 234 are controls to cause different actions. In response to an activation of element 232 to view compatible products, which may be selected from an inventory, or element 234 to create artificial products, which may be created dynamically, a compatible article of furniture will be presented at the designated location. For instance, a coffee table, which is compatible with couch 244, love seat 248, and end table 246 both in shape and appearance, will be presented at location 252.

GUI 200 may be integrated with an e-commerce site or used by customers in a local store. For example, traditionally customers are not permitted to rearrange the furniture in a furniture store, and customers are left to envision how a new piece of furniture would fit with others. Now, when enabled by the disclosed technologies, retailers or e-commerce platforms can customize their products (e.g., furniture) for users based on user interactions. Advantageously, retailers or e-commerce platforms can now recommend compatible products, and customers can visually see how a new piece of furniture would fit with others. This new level of customization will greatly improve customer satisfaction and result in increased sales and reduced returns.

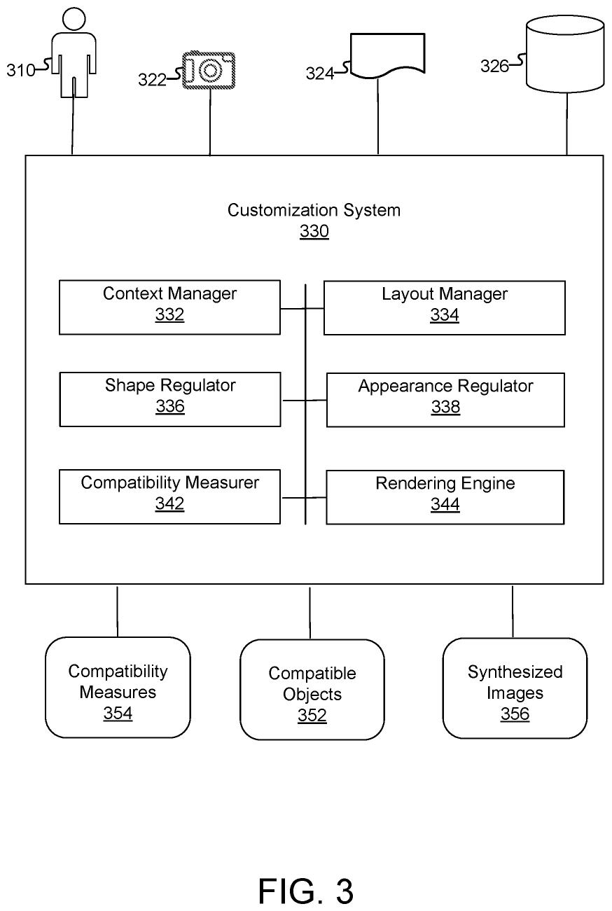

Referring to FIG. 3, an exemplary customization system 330 is shown for implementing the disclosed technologies. This customization system is merely one example of a suitable computing environment and is not intended to suggest any limitation as to the scope of use or functionality of aspects of the technologies described herein. Neither should this customization system be interpreted as having any dependency or requirement relating to any one component nor any combination of components illustrated.

Customization system 330 is configured to measure compatibilities and generate compatible objects or synthesized images with compatible objects. In some embodiments, customization system 330 can generate compatible objects 352, which are new diverse objects that are compatible with the contextual objects. In some embodiments, customization system 330 uses compatibility measures 354 to rank a set of objects based on their respective compatibility measures with the contextual objects, which may be retrieved either from camera 322 or file 324. Customization system 330 is configured to enable user 310 to select an object from storage 326 that is compatible with the contextual objects. In various embodiments, customization system 330 enables user 310 to view the selected or generated compatible object in an agreeable combination with contextual objects as synthesized images 356. So that customization system 330 can enable user 310 to have the visual confirmation for the compatibility.

In addition to other components not shown in FIG. 3, customization system 330 includes context manager 332, layout manager 334, shape regulator 336, appearance regulator 338, compatibility measurer 342, and rendering engine 344 operatively coupled with each other. It should be understood that this arrangement in customization system 330 is set forth only as an example. Other arrangements and elements (e.g., machines, networks, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

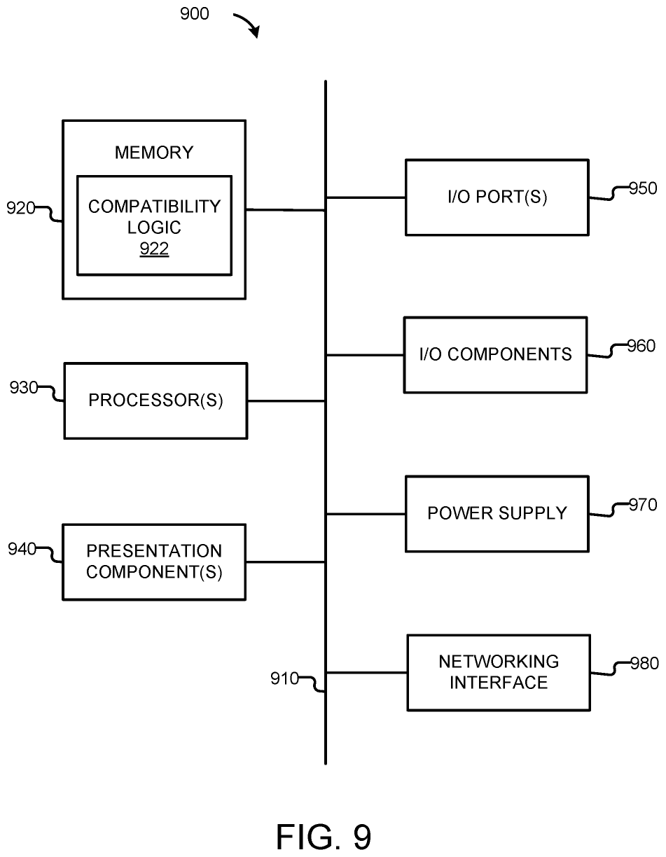

It should be understood that each of the components shown in customization system 330 may be implemented on any type of computing devices, such as computing device 900 described in FIG. 9. Further, each of the components may communicate with various external devices via a network, which may include, without limitation, a local area network (LAN) or a wide area network (WAN).

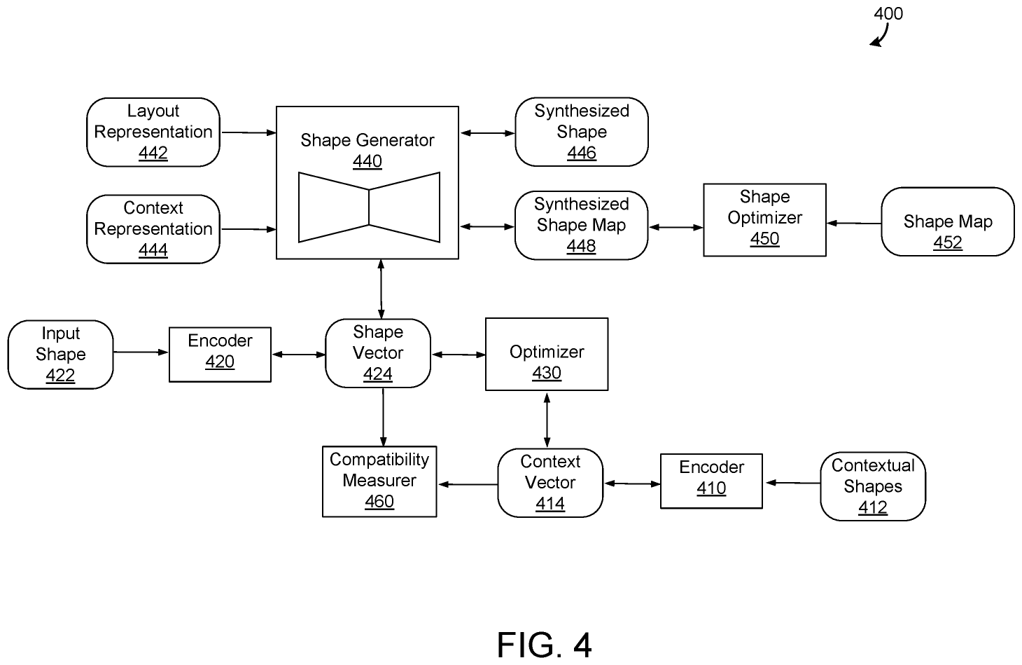

Context manager 332 is generally configured to manage contextual objects, and provide a context representation to a shape network, which will be further discussed in connection with FIG. 4. In various embodiments, context manager 332 uses segmentation and object recognition technologies to identify respective classes of the contextual objects in the source image. In some embodiments, the contextual objects may be manually identified by a user. In other embodiments, the contextual objects may be automatically identified by the system. As an example, context manager 332 may use a parser to segment the source image into different segments, and then classify each segment. In some embodiments, a configuration file from files 324 may identify the parser and the classification system based on the specific practical application that implements the disclosed technologies. For example, for the practical application connected to FIG. 1, a human parser may be used to segment and recognize different parts of the person, including face and hair, upper body skin (e.g., torso, arms), lower body skin (e.g., legs), hat, top clothes (e.g., upper clothes, coat), bottom clothes (e.g., pants, skirt, dress), shoes, and background. As another example, for the practical application connected to FIG. 2, a furniture parser may be used to recognize different types of furniture, including 1-seaters, 2-seaters, 3-seaters, etc.

Layout manager 334 is generally configured to manage the layout of the source image or the synthesized image, and provide a layout representation to a shape network, which will be further discussed in connection with FIG. 4. In some embodiments, layout manager 334 is to generate a representation of the layout of the source image, which specifies the spatial relationship of different segments or items in an image. For example, for the practical application connected to FIG. 1, a person representation (e.g., a person segmentation map, a key-point-based person representation, etc.) may be generated by layout manager 334 via various person parsers. As another example, for the practical application connected to FIG. 2, a layout representation (e.g., a floor plan map, a key-point-based design representation, etc.) may be generated by layout manager 334 via various structure parsers, such as discussed in “Parsing Floor Plan Images,” by Dodge, et. al.; or “Automatic structural scene digitalization,” by Tang, et. al.

Shape regulator 336 is configured to regulate the shape of a generated object to be compatible with respective shapes of the contextual objects in a shared compatibility space, further to enable two encoders to interact with each other to learn shape latent code in the shared compatibility space, which will be further discussed in more details in connection with FIG. 4.

To generate diverse compatible shapes, shape regulator 336 may coordinate rendering engine 344 to regulate the generation process for producing compatible synthesized results with diversity, conditioned on the two encoders. To measure compatibility during the inference stage, one encoder is to encode the shape of a candidate object into a candidate vector in the shared compatibility space, and the other encoder is to encode the shapes of the contextual objects into a context vector in the shared compatibility space. Therefore, compatibility measurer 342 may measure the compatibility of these two vectors, such as based on their distance in the shared compatibility space, and produce shape-related compatibility measures 354 between the candidate object and the contextual objects.

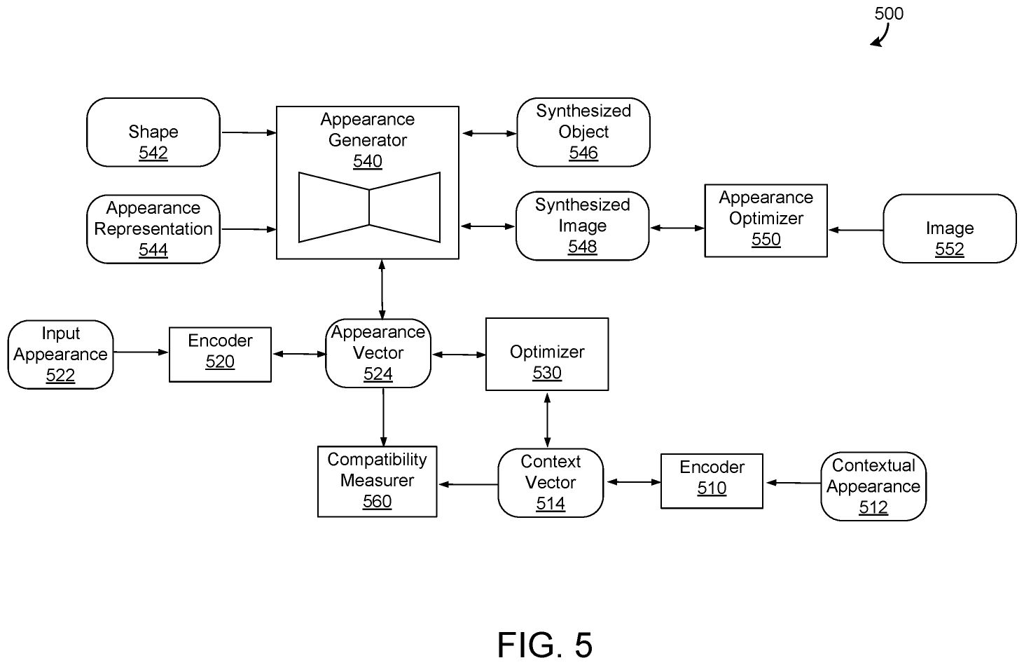

Similarly, appearance regulator 338 is configured to regulate the appearance of a generated object to be compatible with respective shapes of the contextual objects in a shared compatibility space, further to enable two encoders to interact with each other to learn appearance latent code in the shared compatibility space, which will be further discussed in more details in connection with FIG. 5. To generate diverse compatible appearance, appearance regulator 338 may coordinate rendering engine 344 to regulate the generation process for producing compatible synthesized results with diversity, conditioned on the two encoders. To measure compatibility during the inference stage, one encoder is to encode the appearance of a test object into a test vector in the shared compatibility space, and the other encoder is to encode the appearance of the contextual objects into a context vector in the shared compatibility space. Therefore, compatibility measurer 342 may measure the compatibility of these two vectors, such as based on their distance in the shared compatibility space, and produce appearance-related compatibility measures 354 between the candidate object and the contextual objects.

In various embodiments, compatibility measures 354 include shape-related compatibility measures, appearance-related compatibility measures, or a combination thereof. Resultantly, compatibility measures 354 may be used by customization system 330 to rank candidate objects based on their compatibility measures with the contextual objects, and further to customize product recommendations based on the contextual objects.

In various embodiments, compatible objects 352 includes shape-compatible objects, appearance compatible objects, or a combination thereof. Resultantly, compatible objects 352 may be used by customization system 330 to facilitate a creative process, such as fashion design, interior design, game design, etc.

Customization system 330 can present highly ranked compatible objects or generated compatible objects independently (e.g., element 126 or element 128 in FIG. 1), or present them with their contextual objects in synthesized images 356 (e.g., synthesized images in element 144 or element 146 in FIG. 1). In various embodiments, rendering engine 344 may synthesize a compatible object and its contextual object based on the layout identified by layout manager 334. Resultantly, customization system 330 enables users to visually evaluate the compatibility and identify their preferred products or designs.

Referring now to FIG. 4, a schematic representation is provided illustrating an exemplary shape network, which is designated generally as network 400, in accordance with at least one aspect of the technologies described herein. In various embodiments, network 400 is implemented with neural networks, e.g., convolutional neural networks.

Network 400 is configured to correlate input shape 422 and contextual shapes 412 into a latent compatibility space during the training stage, so that compatibility measurer 460 can measure their compatibility during the inference stage. Further, network 400 is configured to use shape generator 440 to generate synthesized shape 446 (denoted as “S” in various discussions) or synthesized shape map 448 (denoted as “S” in various discussions) using layout representation 442 and context representation 444, conditioned on the compatible target shape information captured by shape vector 424, which is connected to the learned latent compatibility space.

Training images having compatible objects are used for training network 400. Such compatible objects may be manually labeled. Alternatively, the compatibility of two objects may be presumed based on their co-occurrence, e.g., in a same catalog image, in a same purchase order, etc. In this way, significant training data may be collected automatically.

Shape map 452 (also denoted as “S” in various discussions) may be obtained from the training images, e.g., based on using segmentation technologies and object recognition technologies. During training, one of the objects in the training image may be selected as the target, and the remaining objects become the context for the target. Accordingly, the shape of the target becomes input shape 422 (denoted as “xₛ” in various discussions), and the respective shapes of the contextual objects become contextual shapes 412. In some embodiments, layout representation 442 (also denoted as “pₛ” in various discussions) is a general representation of various layouts of shape map 452. In other embodiments, layout representation 442 could be the representation of the specific layout of a specific instance of shape map 452. In various embodiments, context representation 444 (also denoted as “g” in various discussions) is a specific representation of a specific instance of shape map 452, by masking out a specific instance of input shape 422.

In some embodiments connected to FIG. 1, to train network 400, a human parser is pretrained on a person dataset, e.g., the Look Into Person dataset. Specifically, the human parser is to produce a segmentation map for an input image IϵR^{H×W×3} The segments may then be classified into various classes, including face and hair, upper body skin (torso+arms), lower body skin (legs), hat, top clothes (upper-clothes+coat), bottom clothes (pants+skirt+dress), shoe, and background (others). In this example, the 8-class parsing results are then transformed into an 8-channel binary map Sϵ{0,1}^{H×W×3} which is used as an instance of shape map 452, also serves as the ground truth of synthesized shape map 448. For the purpose of this example, only the aforementioned eight classes are used, although network 400 is generic and can be extended to cover more fine-grained classes.

Each segment may have a corresponding segmentation mask, so that when a target class is selected, the segment of the target class may be masked out. In this way, context representation 444 without the target class may be generated by masking out the area of a specific segment in the target class from shape map 452. For instance, in connection with FIG. 1, when “top” is selected by the user, Ŝ may be produced by masking out the top region of S, including the top clothing and upper body skin in one embodiment.

Layout representation 442 may be used to preserve the general layout of the source image. In this embodiment, a clothing-agnostic layout representation, including a pose representation and the hair and face layout, may be used to preserve the pose and identify of the person in the source image. Specifically, the pose representation contains an 18-channel heatmap extracted by a pose estimator trained on the COCO keypoints detection dataset, and the face and hair layout is computed from a human parser represented by a binary mask whose pixels in the face and hair regions are set to 1. Both representations are then concatenated to form pₛϵR^{H×W×C}^{ₛ}, where the number of channels (Cₛ) now becomes 19.

In various embodiments, shape generator 440 (Gₛ) is configured as an encoder-decoder based generator, e.g., implemented with neural networks. In some embodiments, Ŝ and pₛ are directly used to reconstruct S, i.e., Gₛ(Ŝ, pₛ), e.g., using image-to-image translation networks. This will train shape generator 440 to generate a unique output without diversity. In other embodiments, in addition to Ŝ and pₛ, shape generator 440 is to generate synthesized shape 446 or synthesized shape map 448 based on shape vector 424 (zₛ) during the training, which introduces shape diversity. When conditioned on the latent shape vector zₛϵR^{Z}, which encourages diversity through sampling during inference, shape generator 440 can produce various shapes compatible with the given contextual objects. At the inference stage, context vector 414 (yₛ) may be sampled when the shape vector 424 (zₛ) is unavailable.

Shape vector 424 may be trained to encode shape information with encoder 420 (denoted as “Eₛ” in various discussions). Given input shape xₛ, Eₛ outputs zₛ, leveraging a re-parameterization technique to enable a differentiable loss function, denoted as zₛ˜Eₛ(xₛ). In some embodiments, zₛ is forced to follow a Gaussian distribution [symbol] (0, [symbol] ) during training, which enables stochastic sampling at the test time if xₛ is unknown, based on Eq. 1. Here, D_{KL}(p∥q) is the KL divergence in Eq. 2.

$$\begin{matrix}{L}_{KL} = {D}_{KL} ( {E}_{s} ( {x}_{s} ) ‖ ( ( 0 , ) ) & Eq . 1 \\ {D}_{KL} ( p ‖ q ) = \vert - \int p ( z ) log \frac{p ( z )}{q ( z )} dz & Eq . 2\end{matrix}$$

Then, shape generator 440 (Gₛ) may use the learned latent vector zₛ, together with Ŝ and pₛ to produce S̅ with masked region filled, as in Eq. 3.

S̅=Gₛ(Ŝ,pₛ,zₛ) Eq. 3

Further, shape generator 440 is optimized via shape optimizer 450 by minimizing the cross entropy segmentation loss (L_{seg}) between S̅ and S, as in Eq. 4 in some embodiments, where C is the number of channels of shape map 452.

$${L}_{seg} = - \frac{1}{HW} {\sum }_{m = 1}^{HW} {\sum }_{c = 1}^{C} S log ( \overline{S} ) \qquad Eq . 4$$

In some embodiments, encoder 420 (Eₛ) and shape generator 440 (Gₛ) can be optimized jointly by minimizing L in Eq. 5, where λ_{KL} is a weight balancing two loss terms.

L=L_{seg}+λ_{KL}L_{KL} Eq. 5

During the inference time, one can directly sample from [symbol] (0, [symbol] ) to generate zₛ, enabling the reconstruction of a diverse set of results, as in Eq. 6.

S̅=Gₛ(Ŝ,pₛ,zₛ) Eq. 6

Input shape 422 and contextual shapes 412 are correlated in a latent compatibility space. In other words, if a target object is compatible with its contextual objects, its shape may be determined by the shapes of its contextual objects. For instance, given a men's tank top in the contextual garments and the bottom as the target class, the compatible shape of the target class is more like men's shorts than a skirt.

Network 400 needs to be further trained to use compatibility measurer 460 for measuring compatibility between input shape 422 (xₛ) and contextual shapes 412 (x_{c}) in this latent compatibility space. To this end, encoder 410 and encoder 420 may be optimized via optimizer 430, with the goal of building the latent compatibility space based on the correlations between xₛ and x_{c}. Further, shape vector 424 (zₛ) needs to be further configured to enable the various shapes generated by shape generator 440 to be visually compatible with their contextual shapes. To this end, the sampling process connected to zₛ may be partially conditioned on x_{c}.

In some embodiments, segments of shape map 452 (S) may be used to form x_{c}, e.g., by concatenating these segments in an order, e.g., from top to bottom, from bottom to top, from left to right, from right to left, etc. For instance, in connection with FIG. 1, x_{c} may be formed by concatenating segments from top to bottom, i.e., from hat to shoes. Subsequently, encoder 410 (E_{cs}) may project x_{c} into context vector 414 (yₛ) (denoted as: yₛ˜E_{cs}(x_{c})).

Optimizer 430 may be configured to identify the latent compatibility space for xₛ and x_{c} to share, e.g., via the KL divergence in Eq. 7, which penalizes the distribution of zₛ encoded by Eₛ(xₛ) for being too far from its compatibility latent vector yₛ encoded by E_{cs}(x_{c}), such that the correlation information between xₛ and x_{c} can be built into the latent compatibility space.

\hat{L}_{KL}=D_{KL}(Eₛ(xₛ)∥E_{cs}(x_{c})) Eq. 7

The final objective function of network 400 may then be formulated as Eq. 8.

Lₛ=L_{seg}+λ_{KL}\hat{L}_{KL} Eq. 8

The shared latent space of zₛ and yₛ can be considered as the latent compatibility space. Here, instead of reducing the distance between two compatible samples, the difference between two distributions (zₛ and yₛ) are minimized. Resultantly, shape generator 440 can generate diverse multi-modal shapes or shape maps based on zₛ during the training, e.g., according to Eq. 9. When xₛ is not available during the inference stage, yₛ from E_{cs}(x_{c}) may be sampled to compute S′ or S̅, e.g., according to Eq. 10

S′|S̅=Gₛ(Ŝ,pₛ,zₛ) Eq. 9

S′|S̅=Gₛ(Ŝ,pₛ,yₛ) Eq. 10.

In another aspect, the trained encoder 410 and encode 420 are now aware of the inherent compatibility information embedded in the latent compatibility space. Consequently, during the inference stage, compatibility measurer 460 can measure the compatibility between a given target object and its contextual objects. By way of example, encoder 420 may project the target object into a target vector, and encoder 410 may project its contextual objects into a context vector. The distance or similarity between the target vector and the context vector may then be measured in the latent compatibility space, where a shorter distance or a higher similarity between the two vectors indicates a higher compatibility. In this way, a set of different candidate objects may be ranked based on their compatibility measures with the same set of contextual objects.

Having discussed network 400, which is directed to shape compatibility, now referring to FIG. 5, a schematic representation is provided illustrating an exemplary network for appearance compatibility, which is designated generally as network 500. In various embodiments, network 500 is implemented with neural networks, e.g., convolutional neural networks. Network 500 is structurally similar to network 400, including appearance generator 540 for appearance reconstruction, which is denoted as an encoder-decoder generator Gₐ in some embodiments. To generate a diverse compatible appearance, appearance generator 540 may use appearance vector 524 (zₐ), which is denoted as an input appearance code distribution or a latent appearance vector in some embodiments. Encoder 520 (Eₐ) is to encode input appearance 522 (xₐ) into appearance vector 524 (zₐ), while encoder 510 (E_{ca}) is to encode contextual appearance 512 (x_{ca}) into context vector 514 (yₐ), which is a latent appearance compatibility vector. Input appearance 522 (xₐ) includes the appearance of the selected training or target object, which corresponds to input shape 422 in FIG. 4. Optimizer 530, like optimizer 430, is configured to converge zₐ and yₐ into a latent compatibility space, such that the correlation information between xₐ and x_{ca} can be built into the latent compatibility space.

Differently, appearance generator 540 (Gₐ) utilizes shape 542 (pₐ), appearance representation 544 (Î), and appearance vector 524 (zₐ) to generate synthesized object 546 or synthesized image 548. In some embodiments, to generate synthesized image 548, shape 542 may use a copy of synthesized shape map 448 from network 400. In some embodiments, to generate synthesized object 546, shape 542 may use a copy of synthesized shape 446 from network 400. As such, Gₐ projects compatible appearances to the compatible shape, as an individual object or in a combination with its contextual objects.

In one embodiment, during the training, shape 542, pₐϵR^{H×W×11} includes shape map 452 (S), specifically a ground truth segmentation map SϵR^{H×W×8} as well as a face and hair RBG segment in connection with the application in FIG. 1. At the inference time, S̅ may be used in place of S as it is no longer available. In this example, S or S̅ contains richer information than merely using key points about the person's configuration and body shape, and the face and hair image constrains network 500 to preserve the person's identity in synthesized image 548 (Ī), e.g., according to Eq. 11.

Ī=Gₐ(Ī,pₐ,zₐ). Eq. 11

Also unlike Gₛ in FIG. 4 that reconstructs a shape or a shape map by minimizing a cross entropy loss, appearance generator Gₐ here focuses on reconstructing the original image, image 552 (I), e.g., in RGB space, given the appearance representation Î, in which the appearance of the target object is not presented.

To reconstruct I from Ī, appearance optimizer 550 may use a different loss, which contains a perceptual loss that minimizes the distance between the corresponding feature maps of I and Ī in a perceptual neural network, and a style loss that matches their style information, e.g., according to Eq. 12, where ϕₗ(I) is the l-th feature map of image I in a pretrained network, e.g., VGG-19 pretrained on ImageNet. λₗ and γₗ are hyper-parameters balancing the contributions of different layers. By minimizing this loss, the reconstructed image may have the similar high-level contents as well as detailed textures and patterns as the original image.

$${L}_{rec} = {\sum }_{l = 0}^{5} {λ}_{l} {‖ {φ}_{l} ( I ) = {φ}_{l} ( \overline{I} ) ‖}_{1} + {\sum }_{l = 1}^{5} {λ}_{l} {‖ {G}_{l} ( I ) - {G}_{l} ( \overline{I} ) ‖}_{1} \qquad Eq . 12$$

In some embodiments, when l≥1, conv1-2, conv2-2, conv3-2, conv4-2, and conv5-2 layers in the network may be used, while ϕ₀(I)=I. In the second term, Gₗϵ [symbol] ^{C}^{ₗ}^{×C}^{ₗ} is the Gram matrix, which calculates the inner product between vectorized feature maps, e.g., according to Eq. 13, where ϕₗ(I)ϵ [symbol] ^{c}^{ₗ}^{H}^{ₗ}^{W}^{ₗ} is the same as in the perceptual loss term, and Cₗ is its channel dimension.

$${{G}_{l} ( I )}_{ij} = {\sum }_{k = 1}^{{H}_{l} {W}_{l}} {{φ}_{l} ( I )}_{ik} {{φ}_{l} ( I )}_{jk} \qquad Eq . 13$$

In addition, optimizer 530 is configured to construct the latent compatibility space between input appearance 522 (xₐ) and contextual appearance 512 (x_{ca}), also to induce diversity in synthesized appearance (i.e., different textures, colors, etc.) in synthesized object 546 or synthesized image 548. In some embodiments, optimizer 530 may use a KL divergence term according to Eq. 14, such that encoder 510 (E_{ca}) and encode 520 (Eₐ) may converge to the shared compatibility space.

\hat{L}_{KL}=D_{KL}(Eₐ(xₐ)∥E_{ca}(x_{c})) Eq. 14

In various embodiments, the objective function of network 500 may then be obtained according to Eq. 15.

Lₐ=L_{rec}+λ_{KL}\hat{L}_{KL} Eq. 15

Resultantly, network 500, by modeling appearance compatibility in the shared compatibility space, can measure appearance compatibility via compatibility measurer 560, or render a diverse set of visually compatible appearances via appearance generator 540, conditioned on the latent appearance vector 524 (zₐ). When xₐ is not available during the inference stage, yₐ from E_{ca}(x_{ca}) may be sampled, e.g., according to Eq. 16.

Ī=Gₐ(Î,pₐ,yₐ), where yₐ≠E_{ca}(x_{ca}) Eq. 16

In connecting network 400 and network 500, the overall compatibility measure (M_{oc}) of a candidate object may be obtained from a combination of the shape compatibility measure (M_{sc}) and the appearance compatibility measure (M_{ac}), e.g., according to Eq. 17, where λₛ and λₐ corresponding to respective weight assigned based on the specific embodiment.

M_{oc}=λₛM_{sc}+λₐM_{ac} Eq. 17

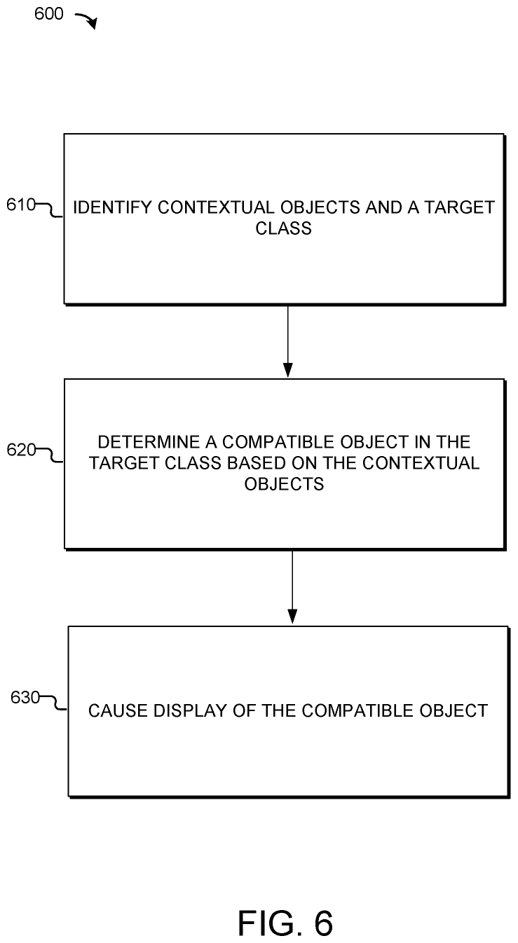

Referring now to FIG. 6, a flow diagram is provided that illustrates an exemplary process 600 of displaying a compatible object, e.g., performed by customization system 330 of FIG. 3.

At block 610, contextual objects and a target class are identified, e.g., by context manager 332 and/or layout manager 334 in FIG. 3. For example, in the practical application in connection with FIG. 1, the target class may be a clothing category, such as top, bottom, shoe, etc. A segmentation map of the source image may be presented to the user. The user can provide an indication of the target class to the system by selecting a segment from the segmentation map. Alternatively, the target class could be selected from the menu with corresponding menu items for available classes. The remaining segments may be identified as contextual objects. Alternatively, the user can select some segments as the contextual objects. As another example, in the practical application in connection with FIG. 2, the target class may be a type of furniture, e.g., coffee table, dining table, end table, etc. The system may automatically identify the target class based on a location and its surrounding objects. Further, various types of furniture recognized in the source image may be selected to serve as the contextual objects.

At block 620, a compatible object in the target class may be determined based on the contextual objects, e.g., via shape regulator 336 and appearance regulator 338 of FIG. 3. In some embodiments, the compatible objects are selected from existing objects based on their corresponding compatibility measures with the contextual objects, e.g., measured by compatibility measurer 460 or compatibility measurer 560. In other embodiments, the compatible object is dynamically generated to be compatible with the contextual objects, e.g., via shape generator 440 and appearance generator 540.

In various embodiments, the system is to determine the object being compatible with the contextual objects in the first aspect of shape based on a latent compatibility space that comprises correlation information between the target shape features of the object and respective shapes features of the contextual objects, and in the second aspect of appearance based on a latent compatibility space that comprises correlation information between the target appearance features of the object and respective appearance features of the contextual objects.

At block 630, the compatible object may be displayed, individually or in combination with the contextual objects, e.g., via rendering engine 344 of FIG. 3. For example, in connection with the practical application described with FIG. 1, the compatible top may be displayed individually as a menu item or in a container in the display area. Further, the compatible top may be displayed with other clothing items together, e.g., according to the layout or representation of the source image. As another example in connection with FIG. 2, a piece of compatible furniture may be displayed at the designated location with other surrounding furniture, e.g., according to the layout of the original floor plan.

In some embodiments, multiple diverse compatible objects may be concurrently displayed for users to compare or select. For example, a retailer may have multiple products compatible with the contextual objects. In this case, the retailer may present the multiple compatible products to the user via a GUI, e.g., based on their corresponding compatibility measures. As another example, the system can sample shape vector 424 or appearance vector 524 to induce diversity into generated images. In this way, new compatible designs may be automatically generated.

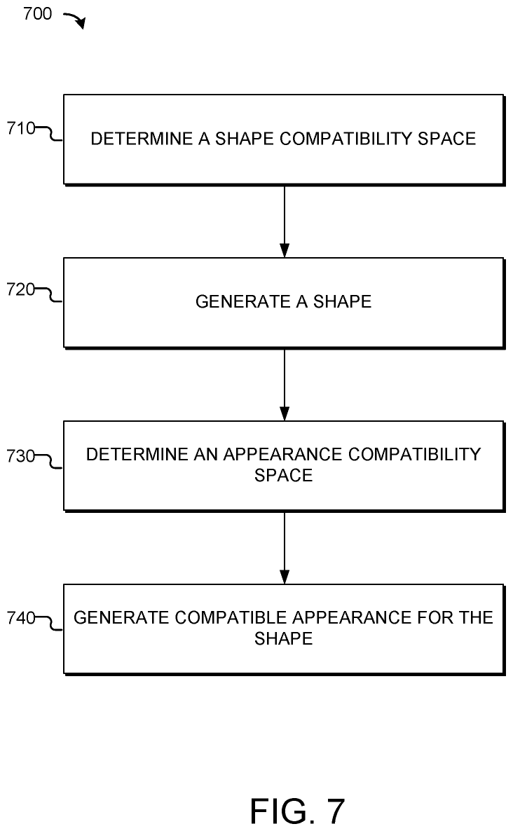

Turning now to FIG. 7, a flow diagram is provided to illustrate an exemplary process 700 of generating a compatible object, e.g., performed by customization system 330 of FIG. 3.

At block 710, the process is to determine a shape compatibility space, e.g., via network 400. In various embodiments, this shape compatibility space is modeled by training a first encoder (Eₛ) to encode the shape features of a target object (xₛ) and a second encoder (E_{cs}) for encoding the shape features of the contextual objects (x_{cs}), so that the correlation information between xₛ and x_{cs} can be modeled into this shape compatibility space, e.g., via Eq. 7, which penalizes the shape vector encoded by Eₛ(xₛ) for being too far from the context latent vector encoded by E_{cs}(x_{cs}) in the shape compatibility space.

At block 720, the process is to generate a shape, e.g., via network 400. In some embodiments, the generated shape includes an individual shape, e.g., synthesized shape 446. In some embodiments, the generated shape includes a synthesized shape map, e.g., synthesized shape map 448, which additionally includes the contextual objects. In various embodiments, the shape is generated based on a layout representation of the source image and a context representation of the contextual objects. Further, diverse shapes compatible with the contextual objects may be generated by sampling the shape vector encoded by Eₛ(xₛ) at the training stage, or the context vector encoded by E_{cs}(x_{cs}) at the inference stage.

At block 730, the process is to determine an appearance compatibility space, e.g., via network 500. Similar to block 710, an optimizer may be used to construct the appearance compatibility space between input appearance (xₐ) and contextual appearance (x_{ca}), such that the appearance compatibility space can reflect the correlation between xₐ and x_{ca}. In some embodiments, the optimizer may use a KL divergence term according to Eq. 14, such that the first encoder for encoding the appearance features of a target object and a second encoder for encoding the appearance features of the contextual objects may converge.

At block 740, the process is to generate compatible appearances for the shape, e.g., via network 500. In various embodiments, the shape used at block 720 is used here to add compatible appearances, e.g., textures, colors, etc. The appearance generator may use the context vector to generate compatible appearances during the inference time.

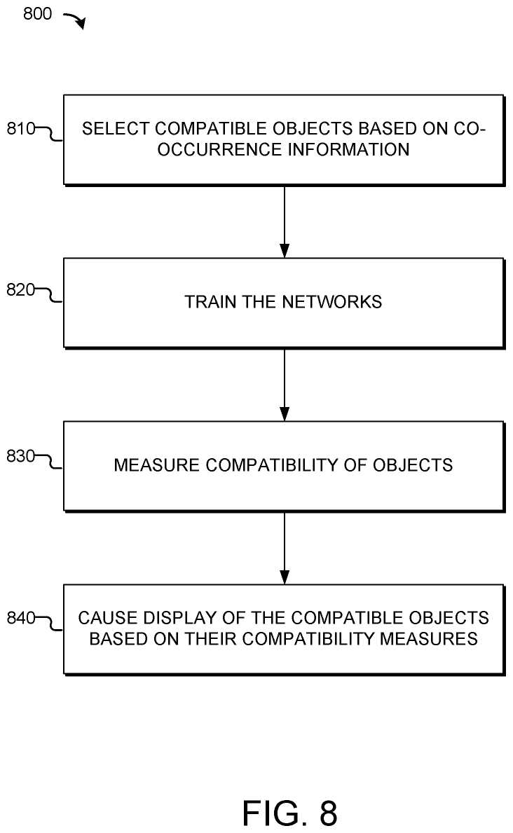

Turning now to FIG. 8, a flow diagram is provided to illustrate an exemplary process 800 of measuring compatibility, e.g., performed by customization system 330 of FIG. 3.

At block 810, the process is to select compatible objects based on their co-occurrence information. For training data, compatible objects may be manually identified or labeled. However, for improved efficacy, compatible objects are automatically identified based on co-occurrence information of multiple objects, e.g., co-occurrence of multiple products in a same catalog image. For example, if a piece of pant and a pair of shoes co-occur in a catalog image, they may be identified as a positive pair of compatible products. Similarly, if a couch and a love seat co-occur in a natural image, they may be identified as two compatible articles of furniture.

At block 820, the process is to train the networks, e.g., network 400 or network 500. Such networks may be trained based on positive or negative compatibility information. In some embodiments, such networks are primarily trained with positive compatibility information automatically gathered from the Internet or an image database. In various embodiments, the training is to minimize the divergence between the two vectors from corresponding encoders, one for encoding the target object and the other for encoding the contextual objects. After the training, a latent compatibility space is constructed for correlating the target object with its contextual objects.

At block 830, the process is to measure compatibility of objects, e.g., via compatibility measurer 460 or compatibility measurer 560. In various embodiments, the distance or similarity between the two vectors, one from the encoder for the candidate object and the other from the encoder for the contextual object, in the latent compatibility space may be used to represent their compatibility measure. In some embodiments, shape compatibility and appearance compatibility are separately measured for two distinctive selection stages. For example, in the first stage, the products may be ranked based on their shape compatibility scores. The top ranked products, e.g., the top 10%, may then be re-ranked based on their appearance compatibility scores. In some embodiments, shape compatibility and appearance compatibility are jointly considered to compute an overall compatibility score, e.g., based on Eq. 17, as previously discussed.

At block 840, the process is to cause display of the compatible objects based on their compatibility measures. In referring to FIG. 1, element 154 may represent the best compatible object, while element 156 may represent the next best compatible object.

Accordingly, we have described various aspects of the technologies for modeling and measuring compatibilities. Each block in process 600, process 700, process 800, and other processes described herein comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

It is understood that various features, sub-combinations, and modifications of the embodiments described herein are of utility and may be employed in other embodiments without reference to other features or sub-combinations. Moreover, the order and sequences of steps/blocks shown in the above example processes are not meant to limit the scope of the present disclosure in any way, and in fact, the steps/blocks may occur in a variety of different sequences within embodiments hereof. Such variations and combinations thereof are also contemplated to be within the scope of embodiments of this disclosure.

Referring to FIG. 9, an exemplary operating environment for implementing various aspects of the technologies described herein is shown and designated generally as computing device 900. Computing device 900 is but one example of a suitable computing environment and is not intended to suggest any limitation as to the scope of use of the technologies described herein. Neither should the computing device 900 be interpreted as having any dependency or requirement relating to any one or combination of components illustrated.

The technologies described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote-processing devices that are connected through a communications network.

With continued reference to FIG. 9, computing device 900 includes a bus 910 that directly or indirectly couples the following devices: memory 920, processors 930, presentation components 940, input/output (I/O) ports 950, I/O components 960, and an illustrative power supply 970. Bus 910 may include an address bus, data bus, or a combination thereof. Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 9 is merely illustrative of an exemplary computing device that can be used in connection with different aspects of the technologies described herein. Distinction is not made between such categories as “workstation,” “server,” “laptop,” “handheld device,” etc., as all are contemplated within the scope of FIG. 9 and refers to “computer” or “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technologies for storage of information such as computer-readable instructions, data structures, program modules, or other data.

Computer storage media includes RAM, ROM, EEPROM, flash memory or other memory technologies, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 920 includes computer storage media in the form of volatile and/or nonvolatile memory. The memory 920 may be removable, non-removable, or a combination thereof. Exemplary memory includes solid-state memory, hard drives, optical-disc drives, etc. Computing device 900 includes processors 930 that read data from various entities such as bus 910, memory 920, or I/O components 960. Presentation component(s) 940 present data indications to a user or other device. Exemplary presentation components 940 include a display device, speaker, printing component, vibrating component, etc. I/O ports 950 allow computing device 900 to be logically coupled to other devices, including I/O components 960, some of which may be built in.

In various embodiments, memory 920 includes, in particular, temporal and persistent copies of compatibility logic 922. Compatibility logic 922 includes instructions that, when executed by processor 930, result in computing device 900 performing functions, such as, but not limited to, processes 600, 700, or 800. In various embodiments, compatibility logic 922 includes instructions that, when executed by processors 930, result in computing device 900 performing various functions associated with, but not limited to various components in connection with customization system 330 in FIG. 3; various components in connection with shape network 400 in FIG. 4; and various components in connection with appearance network 500 in FIG. 5.

In some embodiments, processors 930 may be packed together with compatibility logic 922. In some embodiments, processors 930 may be packaged together with compatibility logic 922 to form a System in Package (SiP). In some embodiments, processors 930 can be integrated on the same die with compatibility logic 922. In some embodiments, processors 930 can be integrated on the same die with compatibility logic 922 to form a System on Chip (SoC).

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 930 may be direct or via a coupling utilizing a serial port, parallel port, and/or other interface and/or system bus known in the art. Furthermore, the digitizer input component may be a component separate from an output component such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technologies described herein.

I/O components 960 include various GUIs, which allow users to interact with computing device 900 through graphical elements or visual indicators, such as various graphical elements illustrated in FIGS. 1-2. Interactions with a GUI usually are performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, a same GUI may have different presentations on different computing devices, such as based on the different graphical processing units (GPUs) or the various characteristics of the display.

Computing device 900 may include networking interface 980. The networking interface 980 includes a network interface controller (NIC) that transmits and receives data. The networking interface 980 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 980 may include a wireless terminal adapted to receive communications and media over various wireless networks. Computing device 900 may communicate with other devices via the networking interface 980 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein has been described in relation to particular aspects, which are intended in all respects to be illustrative rather than restrictive. While the technologies described herein is susceptible to various modifications and alternative constructions, certain illustrated aspects thereof are shown in the drawings and have been described above in detail. It should be understood, however, that there is no intention to limit the technologies described herein to the specific forms disclosed, but on the contrary, the intention is to cover all modifications, alternative constructions, and equivalents falling within the spirit and scope of the technologies described herein.

Lastly, by way of example, and not limitation, the following examples are provided to illustrate various embodiments, in accordance with at least one aspect of the disclosed technologies.

Examples in the first group comprises a method, a computer system configured to perform the method, or a computer storage device storing computer-useable instructions that cause a computer system to perform the method.

Example 1 includes operations for identifying a plurality of contextual objects in a first image, and a target class for an object; determining the object being compatible with the plurality of contextual objects in a first aspect of shape and a second aspect of appearance; and causing display of the object with the plurality of contextual objects in a second image.

Example 2 may include any subject matter of examples in the first group, and further includes operations for parsing the first image into a plurality of segments, wherein identifying the plurality of contextual objects comprises classifying the plurality of segments to respective classes, wherein identifying the target class for the object comprises classifying a user-selected segment from the plurality of segments to the target class.

Example 3 may include any subject matter of examples in the first group, and further includes operations for obtaining a segmentation representation for the first image; and enabling a user to select a segment from the segmentation representation via a user interface, wherein identifying the target class comprises identifying the segment selected by the user, wherein identifying the plurality of contextual objects comprises identifying respective classes of a plurality of segments in the segmentation representation.

Example 4 may include any subject matter of examples in the first group, and further includes operations for determining the object being compatible with the plurality of contextual objects in the first aspect of shape based on a latent compatibility space that comprises correlation information between shape features of the object and respective shape features of the plurality of contextual objects.

Example 5 may include any subject matter of examples in the first group, and further includes operations for determining the object being compatible with the plurality of contextual objects in the second aspect of appearance based on a latent compatibility space that comprises correlation information between appearance features of the object and appearance features of the plurality of contextual objects.

Example 6 may include any subject matter of examples in the first group, and further includes operations for measuring a shape compatibility between a shape of the object with respective shapes of the plurality of contextual objects; and measuring an appearance compatibility between an appearance of the object and respective appearances of the plurality of contextual objects.

Example 7 may include any subject matter of examples in the first group, and further includes operations for generating a shape of the object based on respective shapes of the plurality of contextual objects at a first stage of a generation process; and generating an appearance of the object based on respective appearances of the plurality of contextual objects at a second stage.

Example 8 may include any subject matter of examples in the first group, and further includes operations for using the shape of the object generated from the first stage of the generation process as an input to the second stage of the generation process to generate the appearance of the object.

Example 9 may include any subject matter of examples in the first group, and further includes operations for causing concurrent display of the second image and a third image having another object of the target class, the another object being compatible with the plurality of contextual objects in the first aspect of shape and the second aspect of appearance.

Examples in the second group comprises a method, a computer system configured to perform the method, or a computer storage device storing computer-useable instructions that cause a computer system to perform the method.

Example 10 in the second group includes operations for identifying a target class and a plurality of contextual objects; determining a shape compatibility space and an appearance compatibility space based on the plurality of contextual objects; and generating a plurality of diverse objects of the target class from the shape compatibility space and the appearance compatibility space.

Example 11 may include any subject matter of examples in the second group, and further includes operations for forming a first vector in the shape compatibility space based on shape information of the plurality of contextual objects; forming a second vector in the shape compatibility space based on shape information of training objects in the target class; and minimizing a divergence between the first vector and the second vector.

Example 12 may include any subject matter of examples in the second group, and further includes operations for sampling the first vector to generate a plurality of diverse shape maps.

Example 13 may include any subject matter of examples in the second group, and further includes operations for forming a third vector in the appearance compatibility space based on appearance information of the plurality of contextual objects; forming a fourth vector in the appearance compatibility space based on appearance information of training objects in the target class; and minimizing a divergence between the third vector and the fourth vector.

Example 14 may include any subject matter of examples in the second group, and further includes operations for generating, based on the third vector, a plurality of diverse appearance maps corresponding to the plurality of diverse shape maps.

Example 15 may include any subject matter of examples in the second group, and wherein generating the plurality of diverse objects is based on a machine-learning model that is trained to construct, based on the shape compatibility space, a shape map by minimizing a cross entropy loss between the shape map and a ground truth shape map of a ground truth training image.

Example 16 may include any subject matter of examples in the second group, and wherein the machine-learning model is further trained to construct, based on the appearance compatibility space and the shape map, a synthesized image by minimizing a perceptual loss between the synthesized image and the ground truth training image.

Example 17 may include any subject matter of examples in the second group, and wherein the target class comprises a class of product, and the plurality of diverse objects of the target class comprises different product items in the class of product, wherein each of the different product items being compatible with the plurality of contextual objects in shape and appearance.

Examples in the third group comprises a method, a computer system configured to perform the method, or a computer storage device storing computer-useable instructions that cause a computer system to perform the method.

Example 18 in the third group includes operations for receiving an indication of a target class; identifying a plurality of contextual objects in an image; and causing display of an object of the target class with the plurality of contextual objects in the image, the object being compatible with the plurality of contextual objects in a first aspect of shape and a second aspect of appearance.

Example 19 may include any subject matter of examples in the third group, and further includes operations for determining corresponding compatibility measures between each of a plurality of objects of the target class with the plurality of contextual objects; and causing display of the plurality of objects in an order formed based on the corresponding compatibility measures.

Example 20 may include any subject matter of examples in the third group, wherein determining corresponding compatibility measures comprises determining a perceptual loss between a first image and a second image, the first image including the plurality of contextual objects, and the second image including the plurality of contextual objects and one of the plurality of objects.

What is claimed is:

1. A computer-implemented method for customization, comprising:
identifying a plurality of contextual objects in a first image, and a target class for an object;
determining the object being compatible with the plurality of contextual objects in a first aspect of shape and a second aspect of appearance; and
causing display of the object with the plurality of contextual objects in a second image.

2. The method of claim 1, further comprising:
parsing the first image into a plurality of segments, wherein identifying the plurality of contextual objects comprises classifying the plurality of segments to respective classes, wherein identifying the target class for the object comprises classifying a user-selected segment from the plurality of segments to the target class.

3. The method of claim 1, further comprising:
obtaining a segmentation representation for the first image; and
enabling a user to select a segment from the segmentation representation via a user interface, wherein identifying the target class comprises identifying the segment selected by the user, wherein identifying the plurality of contextual objects comprises identifying respective classes of a plurality of segments in the segmentation representation.

4. The method of claim 1, further comprising:
determining the object being compatible with the plurality of contextual objects in the first aspect of shape based on a latent compatibility space that comprises correlation information between shape features of the object and respective shape features of the plurality of contextual objects.

5. The method of claim 1, further comprising:
determining the object being compatible with the plurality of contextual objects in the second aspect of appearance based on a latent compatibility space that comprises correlation information between appearance features of the object and appearance features of the plurality of contextual objects.

6. The method of claim 1, further comprising:
measuring a shape compatibility between a shape of the object with respective shapes of the plurality of contextual objects; and
measuring an appearance compatibility between an appearance of the object and respective appearances of the plurality of contextual objects.

7. The method of claim 1, further comprising:
generating a shape of the object based on respective shapes of the plurality of contextual objects at a first stage of a generation process; and
generating an appearance of the object based on respective appearances of the plurality of contextual objects at a second stage.

8. The method of claim 7, further comprising:
using the shape of the object generated from the first stage of the generation process as an input to the second stage of the generation process to generate the appearance of the object.

9. The method of claim 1, further comprising:
causing concurrent display of the second image and a third image having another object of the target class, the another object being compatible with the plurality of contextual objects in the first aspect of shape and the second aspect of appearance.

10. A computer-readable storage device encoded with instructions that, when executed, cause one or more processors of a computing system to perform operations comprising:
identifying a target class and a plurality of contextual objects;
determining a shape compatibility space and an appearance compatibility space based on the plurality of contextual objects; and
generating a plurality of diverse objects of the target class from the shape compatibility space and the appearance compatibility space.

11. The computer-readable storage device of claim 10, wherein the instructions that, when executed, further cause the one or more processors to perform operations comprising:
forming a first vector in the shape compatibility space based on shape information of the plurality of contextual objects;
forming a second vector in the shape compatibility space based on shape information of training objects in the target class; and
minimizing a divergence between the first vector and the second vector.

12. The computer-readable storage device of claim 11, wherein the instructions that, when executed, further cause the one or more processors to perform operations comprising:
sampling the first vector to generate a plurality of diverse shape maps.

13. The computer-readable storage device of claim 12, wherein the instructions that, when executed, further cause the one or more processors to perform operations comprising:
forming a third vector in the appearance compatibility space based on appearance information of the plurality of contextual objects;
forming a fourth vector in the appearance compatibility space based on appearance information of training objects in the target class; and
minimizing a divergence between the third vector and the fourth vector.

14. The computer-readable storage device of claim 13, wherein the instructions that, when executed, further cause the one or more processors to perform operations comprising:
generating, based on the third vector, a plurality of diverse appearance maps corresponding to the plurality of diverse shape maps.

15. The computer-readable storage device of claim 10, wherein generating the plurality of diverse objects is based on a machine-learning model that is trained to construct, based on the shape compatibility space, a shape map by minimizing a cross entropy loss between the shape map and a ground truth shape map of a ground truth training image.

16. The computer-readable storage device of claim 15, wherein the machine-learning model is further trained to construct, based on the appearance compatibility space and the shape map, a synthesized image by minimizing a perceptual loss between the synthesized image and the ground truth training image.

17. The computer-readable storage device of claim 10, wherein the target class comprises a class of product, and the plurality of diverse objects of the target class comprises
different product items in the class of product, wherein each of the different product items being compatible with the plurality of contextual objects in shape and appearance.

18. A system for generating compatible objects, comprising:
a processor; and
a memory having instructions stored thereon, wherein the instructions, when executed by the processor, cause the processor to:
receive an indication of a target class;
identify a plurality of contextual objects in an image; and
cause display of an object of the target class with the plurality of contextual objects in the image, the object being compatible with the plurality of contextual objects in a first aspect of shape and a second aspect of appearance.

19. The system of claim 18, wherein the instructions, when executed by the processor, further cause the processor to:
determine corresponding compatibility measures between each of a plurality of objects of the target class with the plurality of contextual objects; and
cause display of the plurality of objects in an order formed based on the corresponding compatibility measures.

20. The system of claim 19, wherein to determine corresponding compatibility measures comprises:
to determine a perceptual loss between a first image and a second image, the first image including the plurality of contextual objects, and the second image including the plurality of contextual objects and one of the plurality of objects.
